(19) United States
(12) Patent Application Publication
(10) Pub. No.: US 2025/0113015 A1
(43) Pub. Date: Apr. 3, 2025

(54) PROJECTION DISPLAY DEVICE

(71) Applicant: SEIKO EPSON CORPORATION, Tokyo (JP)

(72) Inventors: Kohei KOYAMA, Matsumoto-shi (JP); Kazuhisa MIZUSAKO, Shiojiri-shi (JP)

(73) Assignee: SEIKO EPSON CORPORATION, Tokyo (JP)

(21) Appl. No.: 18/899,334

(22) Filed: Sep. 27, 2024

(30) Foreign Application Priority Data
Sep. 29, 2023 (JP) 2023-169452

(51) Int. Cl. H04N 9/31; G09G 3/00; H04N 9/68

(52) U.S. Cl. CPC H04N 9/3185; G09G 3/002; H04N 9/68

(57) ABSTRACT

A projection display device supplies a data signal based on video pixel data A1 corresponding to one unit period to a panel pixel in the one unit period among unit periods constituting one frame, supplies a data signal based on video pixel data C1 corresponding to the one unit period to a panel pixel b1 adjacent to the panel pixel, corrects a first gradation level and a second gradation level so that a difference between the first gradation level of the video pixel data A1 and the second gradation level of the video pixel data C1 is reduced, and adjusts gradation levels of three pieces of video pixel data that are consecutive with respect to the video pixel data A1 in a direction in which the video pixel data C1 is located to a value that is the same as the corrected gradation level of the video pixel data C1.

The present application is based on, and claims priority from JP Application Serial Number 2023-169452, filed Sep. 29, 2023, the disclosure of which is hereby incorporated by reference herein in its entirety.

### BACKGROUND

### 1. Technical Field

The present disclosure relates to a projection display device.

### 2. Related Art

As liquid crystal panels have become smaller and higher in definition in recent years and a gap between pixel electrodes has become narrower, an influence of an electric field generated between adjacent pixel electrodes, that is, an electric field in a direction parallel to a substrate surface (horizontal electric field) has not been able to be ignored. Specifically, the horizontal electric field causes poor alignment of liquid crystal, that is, a domain, which is visually recognized as a display defect.

A technology for correcting video data supplied from an upper device when a horizontal electric field is expected to become stronger and performing correction so that a difference between voltages applied to adjacent pixel electrodes is reduced has been proposed in order to curb the display defect caused by the domain. This type of correction is called a domain correction (see, for example, the description in JP-A-2011-170235).

However, when a configuration in which the projection position of one panel pixel of the liquid crystal panel 100 is shifted by an optical path shift element is applied to domain correction, the brightness of the panel pixel may change as if a moving image were displayed, even when a still image is displayed. To this end, there is a problem that the display quality may be reduced due to the domain.

### SUMMARY

In order to solve the above problem, a projection display device according to an aspect of the present disclosure includes a liquid crystal panel including a plurality of panel pixels, a first panel pixel and a second panel pixel among the plurality of panel pixels being adjacent to each other, an optical path shift element configured to shift an optical path of projection light projected from the panel pixels to shift a position of the projected pixel, and a display control circuit configured to control the liquid crystal panel and the optical path shift element, wherein k (k is an integer equal to or greater than 2) pieces of video pixel data among video pixel data constituting video data input to the liquid crystal panel and arranged in a matrix individually correspond to the first panel pixel in the k unit periods, the k pieces of video pixel data individually correspond to the second panel pixel in the k unit periods, the k pieces of video pixel data corresponding to the first panel pixel and the k pieces of video pixel data corresponding to the second panel pixel are different, and the display control circuit controls the shift of the position of the projected pixel with respect to the optical path shift element for each of the k unit periods, supplies a data signal based on the video pixel data corresponding to the one unit period to the first panel pixel, and the data signal based on the video pixel data corresponding to the one unit period to the second panel pixel in one unit period among the k unit periods, corrects at least a second gradation level so that a difference between a first gradation level of first video pixel data corresponding to the one unit period among the k pieces of video pixel data corresponding to the first panel pixel and the second gradation level of second video pixel data corresponding to the one unit period is reduced, and adjusts gradation levels of k−1 pieces of video pixel data including the second video pixel data that are consecutive with respect to the first video pixel in a direction in which the second video pixel is located to a value that is the same as the corrected second gradation level.

### BRIEF DESCRIPTION OF THE DRAWINGS

FIG. 1 is a diagram illustrating a projection display device according to an embodiment.

FIG. 2 is a block diagram illustrating a configuration of a projection display device.

FIG. 3 is a diagram illustrating one frame and a unit period in the projection display device.

FIG. 4 is a diagram illustrating a relationship between video pixels and panel pixels in the projection display device.

FIG. 5 is a diagram illustrating a relationship between video pixels, panel pixels, and projection positions in one frame.

FIG. 6 is a perspective view showing a configuration of a liquid crystal panel in the projection display device.

FIG. 7 is a cross-sectional view showing a structure of a liquid crystal panel.

FIG. 8 is a block diagram illustrating an electrical configuration of the liquid crystal panel.

FIG. 9 is a diagram illustrating a configuration of a pixel circuit in the liquid crystal panel.

FIG. 10 is a diagram illustrating an example of a V-T characteristic of a liquid crystal element.

FIG. 11 is a diagram illustrating a domain in the liquid crystal panel.

FIG. 12 is a diagram illustrating domain correction and

the like of the related art.

FIG. 13 is a diagram illustrating a first correction.

FIG. 14 is a diagram illustrating a second correction.

FIG. 15 is a diagram illustrating a third correction.

FIG. 16 is a diagram illustrating an example of a processing circuit in an embodiment.

FIG. 17 is a diagram illustrating another example of the processing circuit in the embodiment.

FIG. 18 is a diagram illustrating an example of a coefficient matrix of a filter processing circuit in a processing circuit.

### DESCRIPTION OF EMBODIMENTS

Hereinafter, a projection display device according to an embodiment will be described with reference to the drawings. In each drawing, dimensions and scales of each unit are appropriately different from the actual ones. Further, since embodiments to be described below are preferred specific examples, various technically preferable limitations are applied, but the scope of the present disclosure is not limited to these embodiments as long as description limiting the present disclosure is not present in the following description.

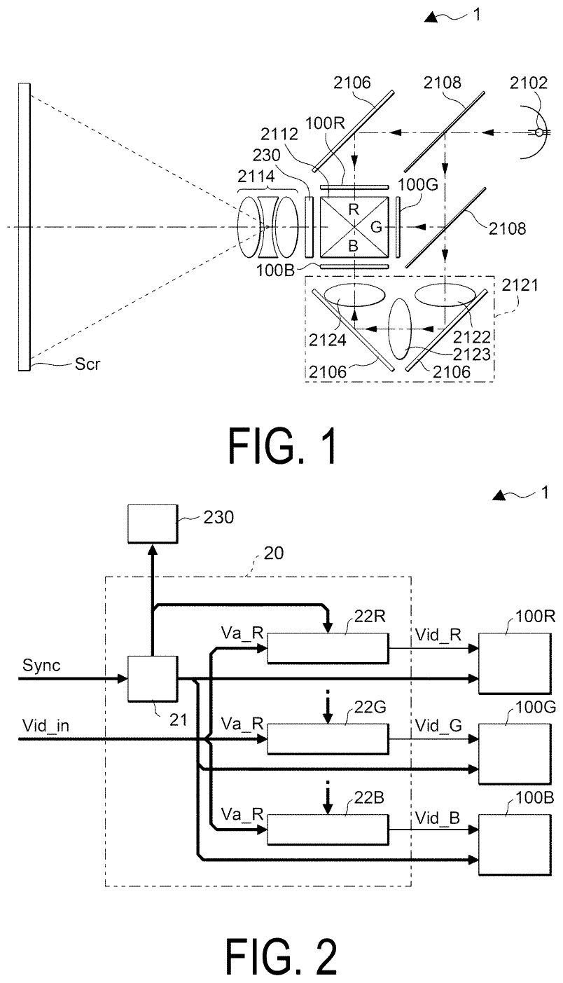

FIG. 1 is a diagram illustrating an optical configuration of a projection display device 1 according to a first embodiment. As shown in the figure, the projection display device 1 includes liquid crystal panels 100R, 100G, and 100B. Further, a lamp unit 2102 including a white light source such as a halogen lamp is provided inside the projection display device 1. The projection light emitted from this lamp unit 2102 is separated into three primary colors of red (R), green (G), and blue (B) by three mirrors 2106 and two dichroic mirrors 2108 disposed inside. Of these, the R light is incident on the liquid crystal panel 100R, the G light is incident on the liquid crystal panel 100G, and the B light is incident on the liquid crystal panel 100B.

Since an optical path of B is longer than optical paths of R and G, it is necessary to prevent loss in the optical path of B. To this end, a relay lens system 2121 including an entrance lens 2122, a relay lens 2123, and an emission lens 2124 is provided in the optical path of B.

The liquid crystal panel 100R includes pixel circuits arranged in a matrix, as described below. The transmittance of light emitted from the liquid crystal element in the pixel circuit is controlled based on a data signal corresponding to R. In other words, in the liquid crystal panel 100R, the light emitted from the liquid crystal element functions as a smallest unit of an image. Under such control, the liquid crystal panel 100R generates an R transmitted image based on a data signal corresponding to R. Similarly, the liquid crystal panel 100G generates a G transmitted image based on a data signal corresponding to G, and the liquid crystal panel 100B generates a B transmitted image based on a data signal corresponding to B.

The transmitted images of respective colors generated by the liquid crystal panels 100R, 100G, and 100B are incident on the dichroic prism 2112 from three directions. In the dichroic prism 2112, the R and B light are refracted at 90 degrees, while the G light travels straight. The dichroic prism 2112 therefore combines the images of the respective colors. The combined light by the dichroic prism 2112 is incident on a projection lens 2114 via an optical path shift element 230. The optical path shift element 230 shifts a path of light emitted from the dichroic prism 2112. In detail, the optical path shift element 230 is capable of shifting an image projected onto a screen Scr in both a left-right direction and an up-down direction with respect to a projection surface.

The projection lens 2114 enlarges and projects the combined image via the optical path shift element 230 onto the screen Scr.

For ease of description, in order to distinguish between pixels projected onto the screen Scr and pixels resulting from a combination of the liquid crystal panels 100R, 100G, and 100B, the pixels projected onto the screen Scr are referred to as projected pixels, and the pixels before or after the combination by the liquid crystal panel 100R, 100G, or 100B are referred to as panel pixels. Further, the position of the projected pixel via the optical path shift element 230 is simply referred to as a projection position.

The images transmitted by the liquid crystal panels 100R and 100B are projected after being reflected by the dichroic prism 2112, whereas the image transmitted by the liquid crystal panel 100G is projected in a straight line. Therefore, the images transmitted by the liquid crystal panels 100R and 100B are in a left-right inverted relationship with the image transmitted by the liquid crystal panel 100G.

FIG. 2 is a block diagram illustrating an electrical configuration of the projection display device 1. As shown in the figure, the projection display device 1 includes a display control circuit 20, the above-described liquid crystal panels 100R, 100G, and 100B, and the optical path shift element 230.

Video data Vid_in is supplied to the display control circuit 20 in synchronization with a synchronization signal Sync from an upper device such as a host device (not shown). The video data Vid_in is data indicating an image to be displayed on the projection display device 1, and in detail, a gradation level of a pixel of the image is designated, for example, by 8 bits for each of RGB.

The pixel of the image designated by the video data Vid_in is referred to as a video pixel, and data for designating the gradation level of the video pixel is referred to as video pixel data, but the video pixels and the video pixel data may not be particularly distinguished from each other in the description. The synchronization signal Sync includes a vertical synchronization signal for instructing the start of vertical scanning in the video data Vid_in, a horizontal synchronization signal for instructing the start of horizontal scanning, and a clock signal indicating a timing for one pixel of the video data.

In the present embodiment, the color image projected onto the screen Scr is expressed by superimposing the respective transmitted images of the liquid crystal panels 100R, 100G, and 100B. Therefore, pixels, which are smallest units of a color image, can be divided into a red panel pixel of the liquid crystal panel 100R, a green panel pixel of the liquid crystal panel 100G, and a blue panel pixel of the liquid crystal panel 100B.

Strictly speaking, the red panel pixel, the green panel pixel, and the blue panel pixel should be referred to as subpixels, but are referred to as panel pixels as described above in the present description.

The liquid crystal panels 100R, 100G, and 100B have the same structure except for only a color, that is, a wavelength of incident light. Therefore, for the liquid crystal panels 100R, 100G, and 100B, 100 is used as a reference sign when it is not necessary to specify the color.

The display control circuit 20 includes a control circuit 21, and processing circuits 22R, 22G, and 22B.

In the present embodiment, a pixel array of the video image designated by the video data Vid_in is, for example, twice as large in a vertical direction and twice as large in a horizontal direction compared with the array of the panel pixels in the liquid crystal panel 100. To this end, in the present embodiment, the projection direction is shifted by the optical path shift element 230 to artificially increase the resolution.

In detail, when one frame of the video image designated by the video data Vid_in is displayed, a period for displaying one frame is divided into four unit periods, and the projection position is shifted for each unit period. Such shifting allows one panel pixel to be visually recognized as if the pixel were displaying four video pixels designated by the video data Vid_in.

A scheme for expressing the four video pixels designated by the video data Vid_in using one panel pixel in the liquid crystal panel 100 will be described before the control circuit 21 and the processing circuits 22R, 22G, and 22B are described.

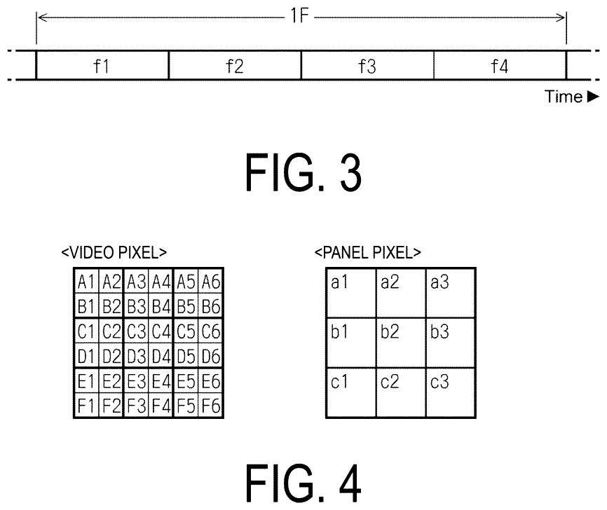

FIG. 3 is a diagram illustrating a relationship between a frame and a unit period in the present embodiment. As illustrated in this figure, in the present embodiment, one frame F is divided into four unit periods. Symbols f1, f2, f3, and f4 are assigned in chronological order in order to conveniently distinguish the four unit periods in the frame F.

The frame F is a period during which one frame of an image represented by the video data Vid_in from an upper device is supplied, and is 16.7 milliseconds, which is one cycle, when a frequency of the vertical synchronization signal included in the synchronization signal Sync is 60 Hz. In this case, a period length of each of unit periods f1 to f4 is 4.17 milliseconds.

Next, a relationship between the video pixel of which the gradation level is designated by the video data Vid_in, the panel pixel of the liquid crystal panel 100, and the projection position of the optical path shift element 230 will be described. The optical path shift element 230 shifts the projection direction from the dichroic prism 2112 as described above, but for convenience, an amount of shift will be described as a size of the projected pixel on the screen Scr.

A left column in FIG. 4 is a diagram illustrating only a portion of an array of the video pixels represented by the video data Vid_in. Further, a right column in FIG. 4 is a diagram illustrating an extracted array corresponding to the video pixels and the array in the left column among panel pixels.

In the array in the left column of the figure, for convenience, symbols A1 to A6 are assigned to a first row, B1 to B6 to a second row, C1 to C6 to a third row, D1 to D6 to a fourth row, E1 to E6 to a fifth row, and F1 to F6 to a sixth row in order to distinguish between the video pixels in the image represented by the video data Vid_in. Similarly, in the array in the right column of FIG. 4, symbols a1 to a3 are conveniently assigned to a first row, b1 to b3 to a second row, and c1 to c3 to a third row in order to distinguish between the panel pixels.

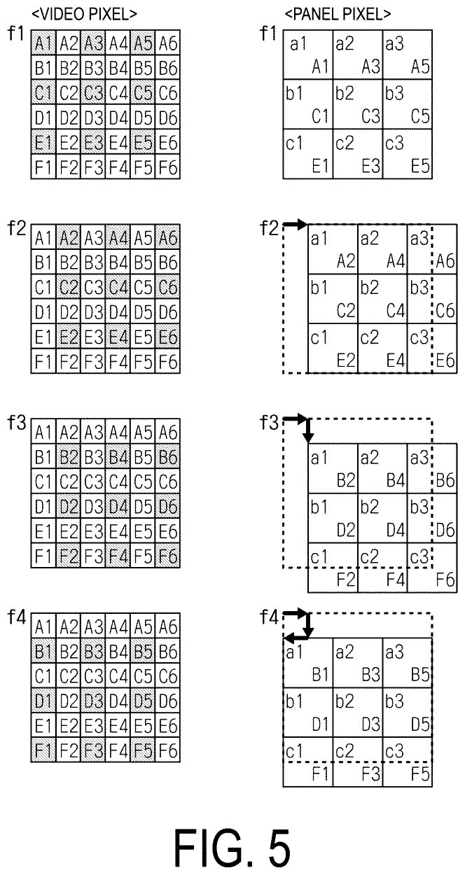

FIG. 5 is a diagram illustrating which video pixels of the image represented by the video data Vid_in are displayed at which projection positions by the panel pixels of the liquid crystal panel 100 in the projection display device 1. In detail, FIG. 5 is a diagram illustrating which video pixels in the array of the video pixels represented by the video data Vid_in in the left column of FIG. 4 are displayed by which of nine panel pixels of the liquid crystal panel 100 in the right column of FIG. 4 and at which projection positions in the unit periods f1 to f4.

For convenience, the projection position in the unit period f1 of the frame F is set as a reference position.

In the unit period f1, the panel pixels a1 to a3, b1 to b3, and c1 to c3 display the video pixels A1, A3, A5, C1, C3, C5, E1, E3, and E5 of the video data Vid_in in order.

In the next unit period f2, the optical path shift element 230 shifts the projection position by 0.5 pixels of the liquid crystal panel 100 in a right direction in the figure from the projection position in the unit period f1 shown by a dashed line. Further, in the unit period f2, the panel pixels a1 to a3, b1 to b3, and c1 to c3 of the liquid crystal panel 100 display the video pixels A2, A4, A6, C2, C4, C6, E2, E4, and E6 of the video data Vid_in in order.

In the unit period f3, the optical path shift element 230 shifts the projection position by 0.5 pixels of the liquid crystal panel 100 in a downward direction in the figure from the projection position in the unit period f2 shown by a dashed line. Further, in the unit period f3, the panel pixels a1 to a3, b1 to b3, and c1 to c3 of the liquid crystal panel 100 display the video pixels B2, B4, B6, D2, D4, D6, F2, F4, and F6 of the video data Vid_in in order.

In the unit period f4, the optical path shift element 230 shifts the projection position by 0.5 pixels of the liquid crystal panel 100 in a left direction in the figure from the projection position in the unit period f3 indicated by a dashed line. Further, in the unit period f4, the panel pixels a1 to a3, b1 to b3, and c1 to c3 of the liquid crystal panel 100 display the video pixels B1, B3, B5, D1, D3, D5, F1, F3, and F5 of the video data Vid_in in order.

After the unit period f4, the optical path shift element 230 shifts the projection position by 0.5 pixels of the liquid crystal panel 100 upward in the figure from the projection position in the unit period f4 to return the position to the position in the unit period f1.

Returning to the description of FIG. 2, the control circuit 21 generates a control signal Ctr for controlling the scanning of the liquid crystal panels 100R, 100G, and 100B for each unit period. Further, the control circuit 21 also controls the projection position of the optical path shift element 230 for each unit period.

Details of the processing circuits 22R, 22G, and 22B will be described later, but the processing circuit 22R processes R component video data Va_R of the video data Vid_in for each of the unit periods f1 to f4, converts the video data Va_R to an analog data signal Vid_R, and supplies the analog data signal Vid_R to the liquid crystal panel 100R.

Similarly, G component video data Va_G of the video data Vid_in is processed for each of the unit periods f1 to f4, the video data Va_G is converted to an analog data signal Vid_G, and the analog data signal Vid_G is supplied to the liquid crystal panel 100G, and B component video data Va_B of the video data Vid_in is processed for each of the unit periods f1 to f4, the video data Va_B is converted to an analog data signal Vid_B, and the analog data signal Vid_B is supplied to the liquid crystal panel 100B.

Next, the liquid crystal panels 100R, 100G, and 100B will be described. The liquid crystal panels 100R, 100G, and 100B are structurally the same, with only color, that is, wavelength, of incident light being different. Therefore, the liquid crystal panels 100R, 100G, and 100B will be generally described with the reference sign 100 without specifying the color.

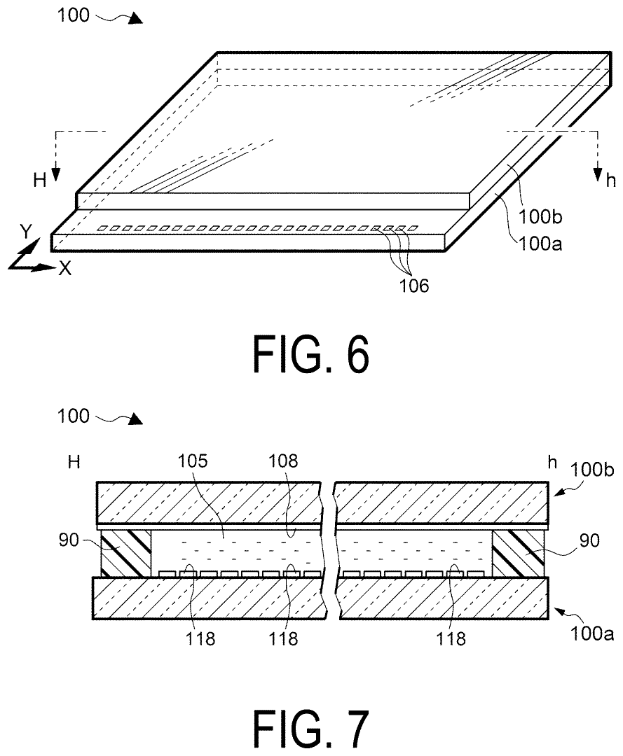

FIG. 6 shows main units of the liquid crystal panel 100, and FIG. 7 is a cross-sectional view taken along a line H-h in FIG. 6.

As shown in these figures, in the liquid crystal panel 100, an element substrate 100a on which pixel electrodes 118 are provided and a counter substrate 100b on which a common electrode 108 is provided are bonded together by a seal material 90 so that electrode formation surfaces face each other while maintaining a certain gap, and this gap is sealed with a liquid crystal 105.

As the element substrate 100a and the counter substrate 100b, a light-transmitting substrate such as glass or quartz may be used. As illustrated in FIG. 3, one side of the element substrate 100a protrudes from the counter substrate 100b. In this protruding area, a plurality of terminals 106 are provided along a horizontal direction in the figure. One end of a Flexible Printed Circuits (FPC) substrate (not shown) is coupled to the plurality of terminals 106. The other end of the FPC substrate is coupled to the display control circuit 20, and the various signals described above are supplied.

On a surface of the element substrate 100a facing the counter substrate 100b, the pixel electrodes 118 are formed by patterning a transparent conductive layer such as an Indium Tin Oxide (ITO).

Further, although not shown, a microlens is provided for each panel pixel on the counter substrate 100b (or the element substrate 100a) in order to efficiently send a large amount of light to an opening that becomes the panel pixel. With this configuration, light repelled by a light shielding portion is sent to an opening of the microlens, improving the efficiency of light utilization.

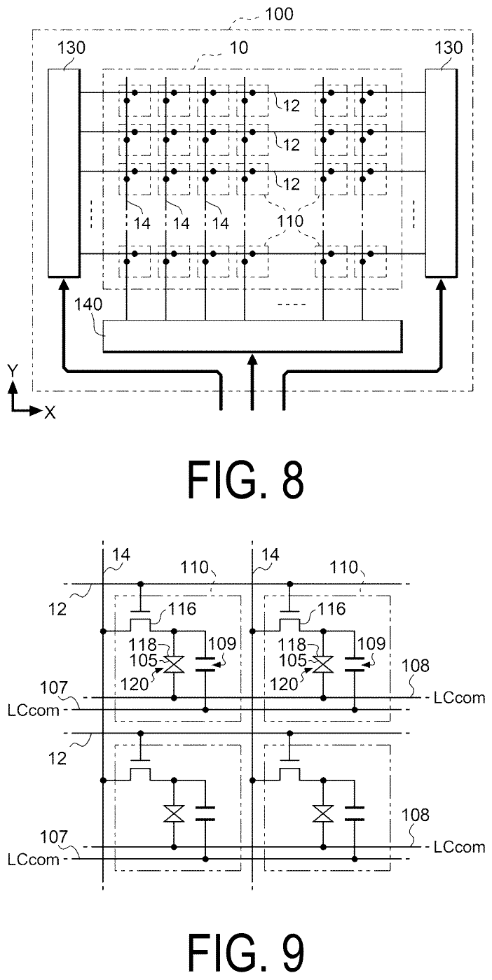

FIG. 8 is a block diagram illustrating an electrical configuration of the liquid crystal panel 100. A scanning line driving circuit 130 and a data line driving circuit 140 are provided on the periphery of a display area 10 of the liquid crystal panel 100.

In the display area 10 of the liquid crystal panel 100, pixel circuits 110 are arranged in a matrix. In detail, in the display area 10, a plurality of scanning lines 12 are provided to extend in a horizontal direction in the figure, and a plurality of data lines 14 are provided to extend in a vertical direction and to be electrically insulated from the scanning lines 12. The pixel circuits 110 are provided in a matrix to correspond to the intersections of the plurality of scanning lines 12 and the plurality of data lines 14.

When the number of scanning lines 12 is m and the number of data lines 14 is n, the pixel circuits 110 are arranged in a matrix of m rows and n columns. m and n are both integers equal to or greater than 2. In the scanning lines 12 and the pixel circuits 110, the rows of the matrix may be called 1st, 2nd, 3rd, . . . , (m−1)th, and mth rows from the top in the figure in order to distinguish between the rows of the matrix. Similarly, in the data lines 14 and the pixel circuits 110, the columns of the matrix may be called 1st, 2nd, 3rd, . . . , (n−1)th, and nth columns from the left in the figure in order to distinguish between the columns of the matrix.

The scanning line driving circuit 130 selects the scanning lines 12 one by one in order of, for example, 1st, 2nd, 3rd, . . . , mth rows under the control of the display control circuit 20, and sets a scanning signal to the selected scanning line 12 to a H level. The scanning line driving circuit 130 sets the scanning signals to the scanning lines 12 other than the selected scanning line 12 to an L level.

The data line driving circuit 140 latches a data signal for one row supplied from the circuit for corresponding color among the processing circuits 22R, 22G, and 22B, and outputs the data signal to the pixel circuit 110 located on the scanning line 12 via the data line 14 during a period in which the scanning signal to the scanning lines 12 is at the H level.

FIG. 9 is a diagram illustrating an equivalent circuit of four pixel circuits 110 in two vertical rows and two horizontal columns corresponding to intersections of two adjacent scanning lines 12 and two adjacent data lines 14.

As shown in the figure, the pixel circuit 110 includes a transistor 116 and a liquid crystal element 120. The transistor 116 is, for example, an n-channel thin film transistor. In the pixel circuit 110, a gate node of the transistor 116 is coupled to the scanning line 12, a source node thereof is coupled to the data line 14, and a drain node thereof is coupled to a pixel electrode 118 having a square shape in plan view.

The common electrode 108 is provided in common to all pixels to face the pixel electrodes 118. A voltage LCcom is applied to the common electrode 108. The liquid crystal 105 is sandwiched between the pixel electrodes 118 and the common electrode 108 as described above. Therefore, for each pixel circuit 110, the liquid crystal element 120 in which the liquid crystal 105 is sandwiched between the pixel electrode 118 and the common electrode 108 is configured.

Further, a storage capacitor 109 is also provided in parallel to the liquid crystal element 120. One end of the storage capacitor 109 is coupled to the pixel electrode 118, and the other end is coupled to a capacitance line 107. A voltage that is constant over time, for example, the same voltage LCcom as the voltage applied to the common electrode 108 is applied to the capacitance line 107. Since the pixel circuits 110 are arranged in a matrix in a horizontal direction, which is a direction in which the scanning lines 12 extend, and a vertical direction, which is a direction in which the data lines 14 extends, the pixel electrodes 118 included in the pixel circuits 110 are also arranged in the vertical and horizontal directions.

In the scanning line 12 on which the scanning signal becomes the H level, the transistor 116 of the pixel circuit 110 provided corresponding to that scanning line 12 is turned on. When the transistor 116 is turned on, the data line 14 and the pixel electrode 118 are electrically coupled, and thus, the data signal supplied to the data line 14 reaches the pixel electrode 118 via the transistor 116 that has been turned on. When the scanning line 12 becomes a L level, the transistor 116 is turned off, but a voltage of the data signal that reaches the pixel electrode 118 is held by a capacitance of the liquid crystal element 120 and the storage capacitor 109.

As is well known, in the liquid crystal element 120, orientation of liquid crystal molecules changes depending on an electric field generated by the pixel electrode 118 and the common electrode 108. Therefore, the liquid crystal element 120 has a transmittance according to an effective value of an applied voltage.

A region of the liquid crystal element 120 that functions as a panel pixel, that is, a region of a transmittance according to the effective value of the voltage is a region where the pixel electrode 118 and the common electrode 108 overlap when the element substrate 100a and the counter substrate 100b are viewed in plan view. Since the pixel electrode 118 is square in plan view, a shape of the pixel in the liquid crystal panel 100 is also square.

Further, in the present embodiment, the liquid crystal 105 is of a vertical alignment (VA) type, and is in a normally black mode in which the transmittance is lowest when a voltage applied to the liquid crystal element 120 is zero and the transmittance increases as the applied voltage increases.

An operation of supplying a data signal to the pixel electrode 118 of the liquid crystal element 120 is executed in order of 1st, 2nd, 3rd, . . . , mth rows in each of the unit periods f1 to f4. Accordingly, a voltage corresponding to the data signal is held in each of the liquid crystal elements 120 of the pixel circuits 110 arranged in the m rows and the n columns, each liquid crystal element 120 has a desired transmittance, and a transmitted image of the corresponding color is generated by the liquid crystal elements 120 arranged in the m rows and the n columns.

Thus, the generation of a transmitted image is executed for each RGB, and a color image obtained by combining RGB is projected onto the screen Scr.

The data signals Vid_R, Vid_G, and Vid_B output corresponding to a certain unit period correspond to RGB components of the video data corresponding to the unit period. To this end, a combined image of a color corresponding to the projection position is projected at the projection position in the unit period.

Here, the domain in the liquid crystal panel 100 will be described.

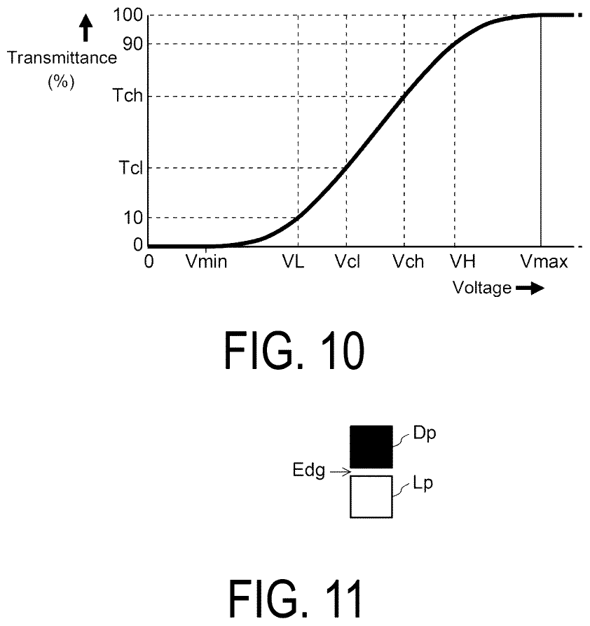

FIG. 10 is a diagram illustrating an example of the applied voltage-transmittance characteristic (VT characteristic) of the liquid crystal element 120 in the normally black mode. In the normally black mode, in a panel pixel (light panel pixel) where a high gradation level is designated and the transmittance is high, the applied voltage in the liquid crystal element 120 is high. On the other hand, in a panel pixel (dark panel pixel) where a low gradation level is designated and the transmittance is low, the applied voltage in the liquid crystal element 120 is low.

For convenience, such a light panel pixel and dark panel pixel are defined as follows.

The light panel pixel is a pixel where, when a voltage corresponding to the gradation level is applied to the pixel electrode 118, the voltage applied to the liquid crystal element 120 including the pixel electrode 118 exceeds VH, and the dark panel pixel is a pixel where the voltage applied to the liquid crystal element 120 is below VL. VH>VL Further, when the voltage applied to the liquid crystal element 120 is the voltage VL, a relative transmittance is, for example, 10%, and when the voltage is the voltage VH, the relative transmittance is, for example, 90%. However, VL and VH may be voltages corresponding to other relative transmittances.

As illustrated in FIG. 11, when the light panel pixel Lp and the dark panel pixel Dp are adjacent to each other in the liquid crystal panel 100, an environment in which a voltage difference between the pixel electrodes 118 becomes large, and the orientation of the liquid crystal molecules is disturbed near a boundary Edg between the two panel pixels due to a lateral electric field generated in a direction along the substrate surface, that is, a domain easily occurs. In general, when the voltage difference between the pixel electrodes 118 becomes large, a degree of the domain occurring near the boundary between the two adjacent panel pixels increases. Panel pixels in which the domain occurs do not have a transmittance corresponding to the gradation level, which causes a decrease in display quality.

Therefore, when only curbing a display defect caused by the domain is considered and the light panel pixel Lp and the dark panel pixel Dp are adjacent to each other, the correction may be performed so that a horizontal electric field generated in the pixel electrode 118 of the light panel pixel Lp and the pixel electrode 118 of the dark panel pixel Dp is reduced.

However, in a configuration in which the projection position of the panel pixel is shifted using the optical path shift element 230, even when the video image designated by the video data Vid_in is a still image, the gradation level may change as in a moving image when viewed from the panel pixel of the liquid crystal panel 100.

A case where the video image is a still image is a case where there is no change in gradation level of the video pixel when previous and subsequent frames are compared.

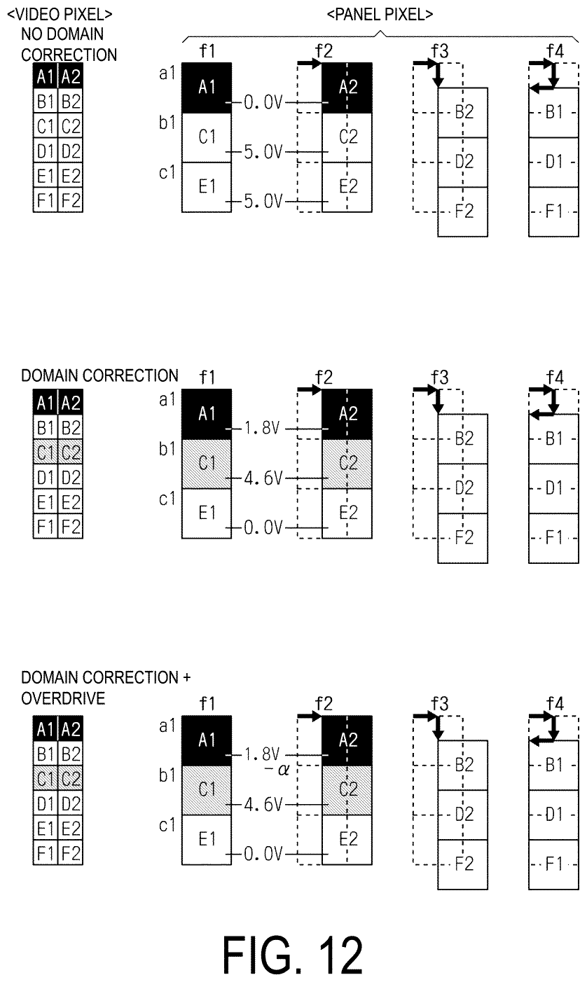

For example, a case where the video pixel that is a still image is as shown in an upper left column of FIG. 12 will be described as an example. In detail, this is a case where the gradation levels of the video pixels A1 and A2 are the black level of a smallest value, and the gradation levels of the other video pixels B1, B2, C1, C2, D1, D2, E1, E2, F2, and F1 are the white level of a greatest value.

In this case, as shown in the upper right column of FIG. 12, the panel pixel a1 expresses the video pixel A1 in the unit period f1, expresses the video pixel A2 in the unit period f2, expresses the video pixel B2 in the unit period f3, and expresses the video pixel B1 in the unit period f4. The panel pixel b1 expresses the video pixel C1 in the unit period f1, expresses the video pixel C2 in the unit period f2, expresses the video pixel D2 in the unit period f3, and expresses the video pixel D1 in the unit period f4. The panel pixel c1 expresses the video pixel E1 in the unit period f1, expresses the video pixel E2 in the unit period f2, expresses the video pixel F2 in the unit period f3, and expresses the video pixel F1 in the unit period f4.

In the unit period f1, the gradation level of the video pixel A1 corresponding to the panel pixel a1 is a black level, and the video pixel C1 corresponding to the panel pixel b1 adjacent to the panel pixel a is a white level. To this end, since the panel pixel a1 becomes the dark panel pixel, and the panel pixel b1 becomes the light panel pixel, the domain correction is executed. Specifically, as shown in a left middle column of FIG. 12, a correction is executed to increase the gradation level of the video pixel A1 from the smallest value, and decrease the gradation level of the video pixel C1 from the greatest value.

When viewed from the array of the video pixels, video pixels of panel pixels adjacent to the panel pixel are the video pixel located in the same column two rows above a video pixel corresponding to a certain panel pixel, the video pixel located in the same column two rows below, the video pixel located two columns to the left on the same row, and the video pixel located two columns to the right in the same row.

For example, in FIG. 5, when a panel pixel b2 expresses a video pixel C3 in the unit period f1, video pixels expressed by the panel pixels a2, c2, b1, and b3 adjacent to the panel pixel b2 are the video pixel A3 located in the same column two rows above the video pixel C3, the video pixel E3 located in the same column two rows below, the video pixel C1 located two columns to the left on the same row, and the video pixel C5 located two columns to the right in the same row in order.

Therefore, when a certain video pixel is expressed by a panel pixel, it is possible to determine whether or not the domain correction is necessary by comparing the gradation level of the video pixel with the gradation levels of the next four video pixels. The four video pixels for the certain video pixel are the video pixel located in the same column two rows above, the video pixel located in the same column two rows below, the video pixel located two columns to the left on the same row, and the video pixel located two columns to the right in the same row, as described above.

It is assumed that the voltage applied to the liquid crystal element 120 corresponding to the black level that is a smallest value of the gradation level is 0 V (volts), and the voltage applied to the liquid crystal element 120 corresponding to the white level that is a greatest value of the gradation level is 5 V. In the domain correction, as shown in a middle right column of FIG. 12, the gradation levels of the video pixels A1 and C1 are individually corrected so that the voltage applied to the liquid crystal element 120 of the panel pixel a1 in the unit period f1 is, for example, 1.8 V and the voltage applied to the liquid crystal element 120 of the panel pixel b1 is, for example, 4.6 V.

Further, in the unit period f1, since the gradation level of the video pixel C1 corresponding to the panel pixel b1 and the gradation level of the video pixel E1 corresponding to the panel pixel c1 are both light panel pixels, the domain correction is not executed.

In the unit period f2, since the panel pixel a1 consecutive from the unit period f1 is the dark panel pixel, and the panel pixel b1 is the light panel pixel, the similar domain correction is executed. Further, in the unit period f2, since the panel pixels b1 and c1 are both light panel pixels, the domain correction is not executed.

In the unit period f3, since the panel pixels a1, b1, and c1 are all light panel pixels, the domain correction is not executed. Similarly, in the unit period f4, since the panel pixels a1, b1, and c1 are all light panel pixels, the domain correction is not executed.

Incidentally, in the liquid crystal panel 100, optical responsiveness to electrical change of the liquid crystal element 120 is lower than the optical responsiveness of other display elements such as organic EL elements. To compensate for the low optical responsiveness, a technology called overdrive is sometimes applied in the liquid crystal panel 100. In detail, the overdrive is, for example, a technology for applying a voltage that is excessively swung in a direction in which the gradation level changes compared to the gradation level designated in the current unit period to the liquid crystal element 120 of the panel pixel corresponding to the video pixel in the current unit period, when there is change in the gradation level in a certain video pixel from an immediately previous unit period to the current unit period.

However, when the overdrive is applied to a configuration in which the domain correction is executed and the optical path shift element 230 is used, the following problem occurs.

That is, as shown in a lower right column of FIG. 12, when return occurs from the unit period f4 to the unit period f1, there is change from the greatest value, which is the gradation level of the video pixel B1, to a level to which the smallest value, which is the gradation level of the video pixel A1, is increased through the domain correction in the panel pixel a1. To this end, the gradation level of the video pixel A1 in the unit period f1 is relatively strongly corrected in a direction in which the gradation level is decreased by the overdrive, but in the domain correction, a correction is executed in a direction in which the gradation level is increased as described above. This causes a problem that the domain correction and the overdrive correction cancel each other out.

Specifically, in the unit period f1, the voltage applied to the liquid crystal element 120 of the panel pixel a1 is increased from 0 V to 1.8V due to the domain correction, but is conversely decreased by a V due to the overdrive, and thus, the domain correction and the overdrive correction cancel each other out.

In the present embodiment, as a first measure, the domain correction is executed so that an intensity of the horizontal electric field in the dark panel pixel and the light panel pixel in a certain unit period is smaller than a voltage difference corresponding to the gradation level designated by the video data. Since the domain correction itself of the first measure is the same as the domain correction of the related art described above, an effect of the correction is canceled out by the overdrive in this state.

Therefore, first correction, second correction, or third correction as shown below is added to the first measure.

The first correction is a correction for aligning gradation levels of three video pixels adjacent and consecutive in a first specific direction with respect to a video pixel corresponding to a dark panel pixel with the gradation level of the video pixel subjected to the domain correction, when viewed from the array of the video pixels. The first specific direction here refers to a direction in which the video pixel corresponding to the light panel pixel is located with the video pixel corresponding to the dark panel pixel as a reference.

The second correction is a correction for aligning gradation levels of three video pixels adjacent and consecutive in a second specific direction with respect to the video pixel corresponding to the light panel pixel with the gradation level of the video pixel to which domain correction has been applied, when viewed from the array of the video pixels. The second specific direction here refers to a direction in which the video pixel corresponding to the dark panel pixel is located with the video pixel corresponding to the light panel pixel as the reference.

The third correction is a correction that is a combination of the first correction and the second correction.

First, an example in which the first correction has been added to the first measure will be described.

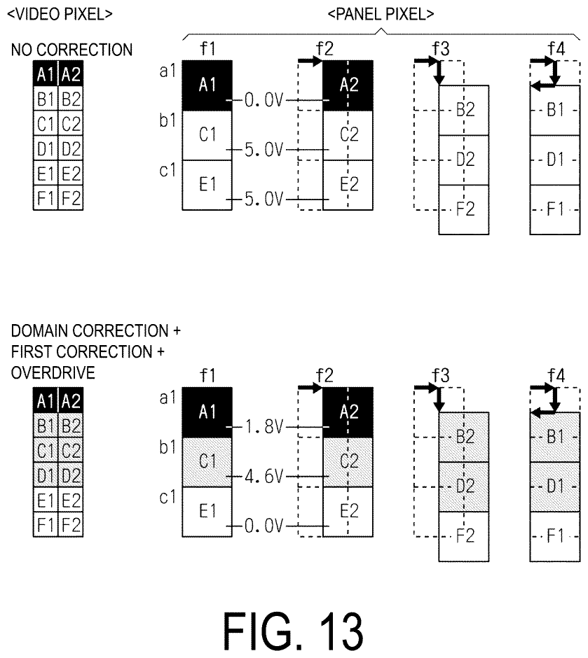

A lower left column and a lower right column of FIG. 13 are diagrams illustrating a case where the first correction has been applied. For comparison, the upper left and upper right columns of FIG. 12 are shown again in upper left and upper right columns of FIG. 13.

First, an example in which the array of the video pixels shown in the upper left column of FIG. 12 or an upper left column of FIG. 13 has been subjected to domain correction using the first measure is as shown in a middle left column of FIG. 12.

In detail, in the array of the video pixels, since the gradation level of video pixel C1 located in the same column two rows below the video pixel A1 of which the gradation level is a smallest value is a greatest value, a correction is performed to increase the gradation level of the video pixel A1 from the smallest value and decrease the gradation level of the video pixel C1 from the greatest value. Similarly, since the gradation level of the video pixel C2 located in the same column two rows below the video pixel A2 of which the gradation level is a smallest value is a greatest value, a correction is performed to increase the gradation level of the video pixel A2 and decrease the gradation level of the video pixel C2.

Next, the first correction added to the first measure will be described. In the array of the video pixels, the first specific direction in which the video pixel C1 corresponding to the light panel pixel b1 is located with the video pixel A1 corresponding to a dark panel pixel a1 as a reference is a downward direction. Therefore, as shown in a lower left column of FIG. 13, the gradation levels of the three video pixels B1, C1, and D1 adjacent and consecutive in a downward direction with respect to the video pixel A1 corresponding to the dark panel pixel a1 are aligned. Since the gradation level of the video pixel C1 decreases from the greatest value through the first measure, the gradation levels of the video pixels B1 and D1 are aligned with the decreased gradation level of the video pixel C1. Similarly, among the gradation levels of the three video pixels B2, C2, and D2 adjacent and consecutive in a downward direction with respect to the video pixel A2 corresponding to the dark panel pixel a1, the gradation levels of the video pixels B2 and D2 are aligned with the decreased gradation level of the video pixel C2.

As a result of the first correction, the video pixels are expressed as shown in a lower right column of FIG. 13 in the panel pixels a1, b1, and c1. In the unit periods f1 and f2, the domain correction is the same as that in the related art. A difference is that, in the unit periods f3 and f4, the panel pixel a1 expresses the video pixels B2 and B1 of which the gradation levels have been increased, and the panel pixel b1 expresses the video pixels D2 and D1 of which the gradation levels have been continuously decreased from the unit periods f1 and f2.

When the first correction is added to the first measure, the voltage applied to the liquid crystal element 120 of the panel pixel a1 in the unit periods f3 and f4 is lower than a voltage corresponding to a maximum white level due to the correction for increasing the gradation level. To this end, since an amount of change in the gradation level decreases at the time of returning from the unit period f4 to f1, an amount of correction by overdrive is also reduced. Therefore, according to the first correction, since a proportion of cancel-out between the domain correction and the overdrive correction decreases, it is possible to curb the cancel-out of the effect of the domain correction due to the overdrive.

Further, since a horizontal electric field between the panel pixels a1 and b1 is weakened due to the correction of the first measure in the unit periods f1 and f2, and the panel pixels a1 and b1 are at the same potential due to the first correction in the unit periods f3 and f4, a display defect due to the domain is early alleviated even when the display defect occurs in the unit periods f1 and f2.

Next, an example in which the second correction is added to the first measure will be described.

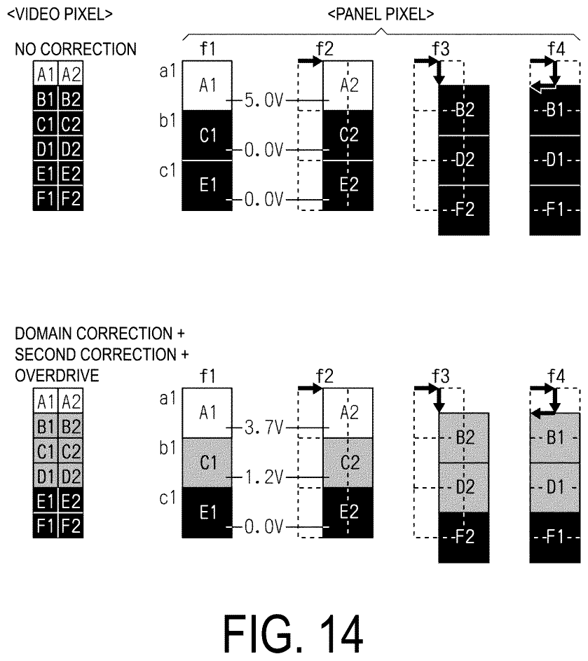

Lower left and lower right columns of FIG. 14 are diagrams illustrating a case where the second correction is applied. For comparison, upper left and upper right columns of FIG. 14 are examples in which the black is inverted to white and white to black in the upper left column of FIG. 13 and the upper right column of FIG. 13.

First, the first measure before the second correction will be described. In the array of the video pixels, the gradation level of the video pixel C1 located in the same column two rows below the video pixel A1 of which the gradation level is a greatest value is a smallest value. To this end, the domain occurs in the panel pixel a1 representing the video pixel A1 and the panel pixel b1 representing the video pixel C1 without correction in the unit period f1. Therefore, a correction is first performed to decrease the gradation level of the video pixel A1 and increase the gradation level of the video pixel C1. Similarly, since the gradation level of the video pixel C2 located in the same column two rows below the video pixel A2 of which the gradation level is a greatest value is the smallest value, a correction is performed to decrease the gradation level of the video pixel A2 and increase the gradation level of the video pixel C2.

Next, the second correction will be described. In the array of the video pixels, the first specific direction in which the video pixel C1 corresponding to the light panel pixel b1 is located with the video pixel A1 corresponding to the light panel pixel a1 as a reference is a downward direction. Therefore, as shown in a lower left column of FIG. 14, the gradation levels of the three video pixels B1, C1, and D1 adjacent and consecutive in the downward direction with respect to the video pixel A1 corresponding to the dark panel pixel a1 are aligned. Since the gradation level of the video pixel C1 increases from the smallest value through the first measure, the gradation levels of the video pixels B1 and D1 are aligned with the increased gradation level of the video pixel C1. Similarly, among the gradation levels of the three video pixels B2, C2, and D2 adjacent and consecutive in the downward direction with respect to the video pixel A2 corresponding to the light panel pixel a2, the gradation levels of the video pixels B2 and D2 are aligned with the increased gradation level of the video pixel C2.

As a result of the second correction, the panel pixels a1, b1, and c1 express the video pixels as shown in the lower right column of FIG. 14. In the unit periods f1 and f2, the domain correction is the same as that in the related art. A difference is that, in the unit periods f3 and f4, the panel pixel a1 expresses the video pixels B2 and B1 of which the gradation levels have been increased, and the panel pixel b1 expresses the video pixels D2 and D1 of which the gradation levels have been continuously increased from the unit periods f1 and f2.

According to the second correction, the voltage applied to the liquid crystal element 120 of the panel pixel a1 in the unit periods f3 and f4 increases above the voltage corresponding to the black level that is a greatest value due to the correction that has decreased the gradation level. Therefore, since an amount of change in the gradation level decreases at the time of returning from the unit period f4 to f1, an amount of correction by the overdrive is also reduced. Therefore, according to the second correction, since the proportion of the cancel-out between the domain correction and the overdrive correction decreases, it is possible to curb the cancel-out of the effect of the domain correction due to the overdrive.

Further, since the horizontal electric field between the panel pixels a1 and b1 is weakened due to the correction of the first measure in the unit periods f1 and f2, and the panel pixels a1 and b1 are at the same potential in the unit periods f3 and f4, the display defect due to the domain is early alleviated even when the display defect occurs in the unit periods f1 and f2.

Next, an example in which a third correction which is a combination of the first correction and the second correction is added to the first measure will be described. In detail, an example in which the first correction is applied to the first measure and the second correction is applied to the first measure will be described.

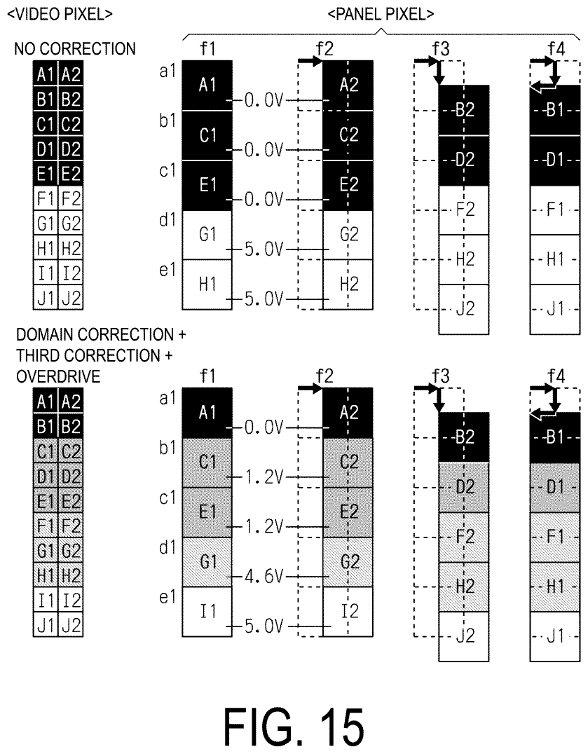

In FIG. 15, lower left and lower right columns are diagrams illustrating a case where the third correction is applied. In the third correction, since a range of the video pixels to be corrected is expanded, an array of the video pixels is expanded compared to the upper columns of FIG. 12 and FIG. 13. In detail, there are five consecutive video pixels A1, B1, C1, D1, and E1 of which the gradation level is a smallest value, and five consecutive video pixels F1, G1, H1, I1, and J1 of which the gradation level is a greatest value. In other words, the video pixel E1 of which the gradation level is a smallest value and the video pixel F1 of which the gradation level is a greatest value are adjacent to each other.

First, the first measure before the first correction will be described.

The gradation level of the video pixel G1 located in the same column two rows below the video pixel E1 of which the gradation level is a smallest value is a greatest value. To this end, since the domain occurs in the panel pixel c1 representing the video pixel E1 and the panel pixel d1 representing the video pixel G1 without correction in the unit period f1, a correction is performed to increase the gradation level of the video pixel E1 and decrease the gradation level of the video pixel G1.

Next, the first correction after the first measure will be described. In the array of the video pixels, the first specific direction in which the video pixel G1 is located with respect to the video pixel E1 is a downward direction. To this end, the gradation levels of the three video pixels F1, G1, and H1 that are adjacent and consecutive in the downward direction with respect to the video pixel E1 are aligned. Since the gradation level of the video pixel G1 has already decreased from the greatest value, the gradation levels of the video pixels F1 and H1 are aligned with the decreased gradation level of the video pixel G1.

Next, the first measure before the second correction will be described.

The gradation level of the video pixel D1 located in the same column two rows above the video pixel F1 of which the gradation level is a greatest value is the smallest level. To this end, since the domain occurs in the panel pixel c1 expressing the video pixel F1 and the panel pixel b1 expressing the video pixel D1 without correction in the unit period f4, a correction is performed to decrease the gradation level of the video pixel F1 and increase the gradation level of the video pixel D1.

However, since the gradation level of the video pixel F1 has already been decreased, there is no need to decrease the gradation level again.

Next, the second correction after the first measure will be described. In the array of the video pixels, the second specific direction in which video pixel D1 is located with respect to the video pixel F1 is an upward direction. To this end, the gradation levels of the three video pixels C1, D1, and E1 that are adjacent and consecutive in the upward direction with respect to the video pixel F1 are aligned. Since the gradation level of the video pixel D1 has already increased from the smallest value, the gradation levels of the video pixels C1 and E1 are aligned with the increased gradation level of the video pixel D1.

Even when there are five consecutive video pixels A2, B2, C2, D2, and E2 and five consecutive video pixels F2, G2, H2, 12, and J2 of which the gradation level is a greatest value, the gradation levels are similarly corrected and aligned.

In the third correction, since the gradation levels of the video pixels F1, F2, G1, G2, H1, and H2 decrease from the greatest values, the voltage applied to liquid crystal element 120 in the panel pixels corresponding to these video pixels becomes, for example, 4.6V slightly lower than the greatest value of 5 V. Moreover, since the gradation levels of the video pixels C1, C2, D1, D2, E1, and E2 increase from the smallest value, the voltage applied to the liquid crystal element 120 in the panel pixels corresponding to these video pixels is, for example, 1.2 V slightly higher than the smallest value of 0 V.

When the third correction is executed in addition to the first measure, the number of stages in which the horizontal electric field generated in the panel pixel is weakened increases compared to the first and second corrections, and thus, it is possible to further curb the degradation of display quality due to the domain. Further, according to the third correction, since the change in gradation level per unit period is small when viewed from one panel pixel, it is possible to curb cancel-out of the effect of the domain correction due to the overdrive.

Next, a specific example of the processing circuits 22R, 22G, and 22B that execute the first correction, the second correction, or the third correction will be described.

FIG. 16 is a block diagram illustrating a configuration of the processing circuits 22R, 22G, and 22B.

As shown in this figure, the processing circuit 22R includes a gamma correction circuit 221, a domain correction circuit 222, a continuous correction circuit 224, a separation circuit 225, and an overdrive correction circuit 226.

In the processing circuit 22R, the gamma correction circuit 221 corrects the gradation level designated by Va_R of the R component of the video data Vid_in to match transmittance characteristics of the liquid crystal element 120 or visual characteristics of humans. For data for which the gradation level designated by the video data Va_R has been corrected, there is no difference in designating the gradation level.

The domain correction circuit 222 focuses on one video image in an array of the video pixels constituting the video data Va_R, and compares the gradation level of the video pixel of interest with gradation levels of four determination video pixel of interests that are adjacent to each other in the unit period, and determines whether or not a domain occurrence condition is satisfied.

The domain occurrence condition is that, when the gradation level of the video pixel of interest is less than a first threshold, the gradation level of the determination video pixel of interest is equal to or greater than a second threshold (first condition), and when the gradation level of the video pixel of interest is equal to or greater than the second threshold, the gradation level of the determination video pixel of interest is less than the first threshold (second condition).

Further, the first threshold is a gradation level at which the voltage applied to the liquid crystal element 120 corresponds to VL, and the second threshold is a gradation level at which the voltage applied to the liquid crystal element 120 corresponds to VH.

When the first condition among the domain generation conditions is satisfied, the domain correction circuit 222 executes any one of corrections for increasing the gradation level of the video pixel of interest, decreasing the gradation level of the determination target pixel, and increasing the gradation level of the video pixel of interest and decreasing the gradation level of the determination target pixel.

In the present embodiment, when the first condition is satisfied, a correction is executed to increase the gradation level of the video pixel of interest and decrease the gradation level of the determination target pixel.

When the second condition among the domain generation conditions is satisfied, the domain correction circuit 222 executes any one of corrections for decreasing the gradation level of the video pixel of interest, increasing the gradation level of the determination target pixel, and decreasing the gradation level of the video pixel of interest and increasing the gradation level of the determination target pixel.

In the present embodiment, when the second condition is satisfied, a correction is executed to decrease the gradation level of the video pixel of interest and increase the gradation level of the determination target pixel.

When the domain occurrence condition is not satisfied, the domain correction circuit 222 does not correct the gradation level of the video pixel of interest and the gradation level of the determination target pixel.

Further, the domain correction circuit 222 performs the determination on all the video pixels while sequentially shifting the video pixel of interests in one frame.

The continuous correction circuit 224 executes the first correction, the second correction, or the third correction described above.

The separation circuit 225 extracts video data corresponding to the unit period designated by the control circuit 21 from the array of the video pixels and outputs the video data.

The overdrive correction circuit 226 performs overdrive correction on the video data of the current unit period output from the separation circuit 225. In detail, the overdrive correction circuit 226 compares the gradation level of the video data in the current unit period with the gradation level of the video data corresponding to the same panel pixel one unit period ago, and adds a correction amount in the direction in which the gradation level changes, which is positive or negative depending on the amount of change, to the gradation level of the video data of the current unit period.

The video data subjected to the overdrive correction is converted into an analog data signal Vid_R by a DA conversion circuit (not shown) and is supplied to the liquid crystal panel 100R.

Further, since the processing circuits 22G and 22B have the same configuration except for color components of input video data and a destination of output data signal, description thereof will be omitted.

The domain correction in the domain correction circuit 222 is, in short, a process for reducing the horizontal electric field generated in adjacent panel pixels. To this end, the domain correction circuit 222 can be replaced by a filter processing circuit that smooths the gradation levels of the video pixels.

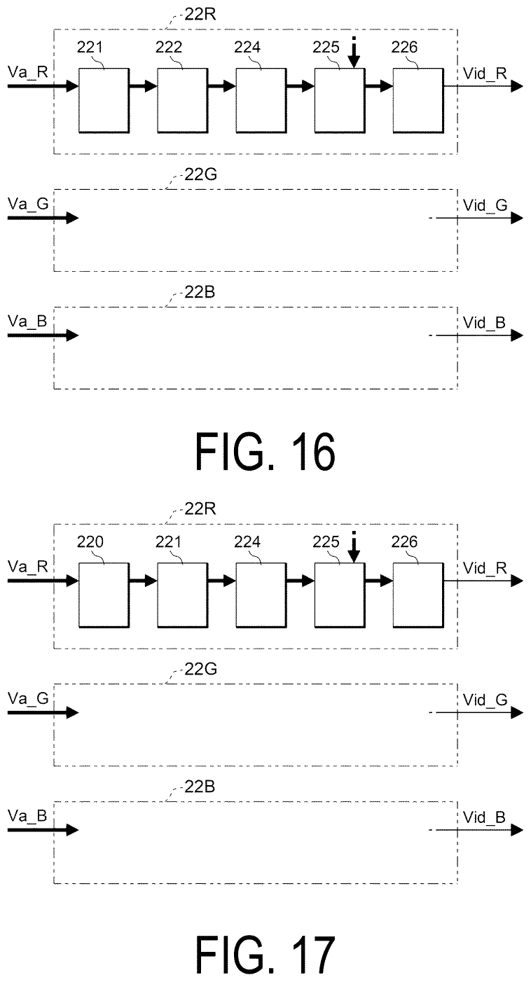

FIG. 17 is a block diagram illustrating a configuration in which the domain correction circuit 222 has been replaced with a filter processing circuit 220. In detail, Va_R of the R component of the video data Vid_in is processed by the filter processing circuit 220, the gamma correction circuit 221, and the continuous correction circuit 224 in order.

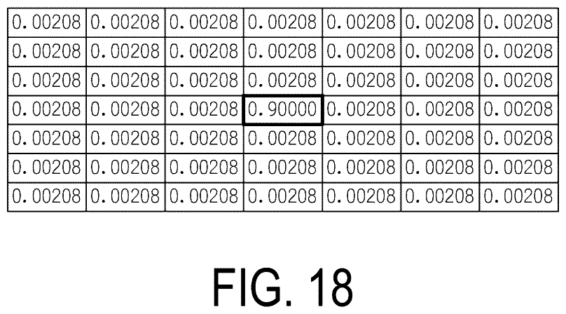

In this configuration, the filter processing circuit 220 smooths the gradation level of the video pixel designated by Va_R of the R component of the video data Vid_in. The smoothing of the gradation level is executed, for example, by using a filter coefficient matrix as illustrated in FIG. 18.

This filter coefficient matrix means processing for multiplying the gradation level of the video pixel of interest by a positive coefficient shown in a thick frame to decrease the gradation level and increasing the gradation level of the video pixel located around the video pixel of interest by an amount multiplied by a coefficient according to a position, when one video image is focused on in the array of the video pixels constituting the video data Va_R and the gradation level of the video pixel of interest is higher than the gradation levels of the surrounding video pixels.

Coefficients in the filter coefficient matrix in FIG. 18 are merely examples, and are an example in which a difference “0.1” (=1−0.9) generated by multiplication of coefficient shown in a thick frame is evenly distributed to 48 surrounding video pixels.

The filter processing circuit 22 smooths all the video pixels while sequentially shifting the video pixels of interest in one frame.

The above-described embodiment can be modified or applied in various ways as follows.

In the embodiment or the like, one frame period is divided into four unit periods. That is, in the description, “4” is an example of k, which is the number of unit periods included in one frame period. k is not limited to “4” and may be any number equal to or greater than “2”.

In the embodiment, the projection position of the optical path shift element 230 is circulated clockwise, but the projection position may be circulated counterclockwise.

From the embodiments illustrated above, the following aspects can be ascertained, for example.

A projection display device according to one aspect (aspect 1) includes a liquid crystal panel including a plurality of panel pixels, a first panel pixel and a second panel pixel among the plurality of panel pixels being adjacent to each other, an optical path shift element configured to shift an optical path of projection light projected from the panel pixels to shift a position of the projected pixel, and a display control circuit configured to control the liquid crystal panel and the optical path shift element, wherein k (k is an integer equal to or greater than 2) pieces of video pixel data among video pixel data constituting video data input to the liquid crystal panel and arranged in a matrix individually correspond to the first panel pixel in the k unit periods, the k pieces of video pixel data individually correspond to the second panel pixel in the k unit periods, the k pieces of video pixel data corresponding to the first panel pixel and the k pieces of video pixel data corresponding to the second panel pixel are different, the display control circuit controls the shift of the position of the projected pixel with respect to the optical path shift element for each of the k unit periods, supplies a data signal based on the video pixel data corresponding to the one unit period to the first panel pixel, and the data signal based on the video pixel data corresponding to the one unit period to the second panel pixel in one unit period among the k unit periods, corrects at least a second gradation level so that a difference between a first gradation level of first video pixel data corresponding to the one unit period among the k pieces of video pixel data corresponding to the first panel pixel and the second gradation level of second video pixel data corresponding to the one unit period is reduced, and adjusts gradation levels of k−1 pieces of video pixel data including the second video pixel data that are consecutive with respect to the first video pixel in a direction in which the second video pixel is located to a value that is the same as the corrected second gradation level.

With the projection display device according to aspect 1, in a configuration in which the projection position is shifted for each unit period using the optical path shift element, it is possible to curb the occurrence of the domain due to a lateral electric field and prevent a deterioration in display quality.

In a specific aspect 2 of aspect 1, the display control circuit corrects the first gradation level in addition to the second gradation level.

In a specific aspect 3 of aspect 2, the display control circuit corrects the first gradation level and the second gradation level when the first gradation level is less than a first threshold and the second gradation level is equal to or greater than a second threshold.

In a specific aspect 4 of aspect 3, the display control circuit corrects the first gradation level less than the first threshold to be equal to or greater than the first threshold, and corrects the second gradation level equal to or greater than the second threshold to be less than the second threshold.

In another specific aspect 5 of aspect 4, the display control circuit performs the correction so that a difference between gradation levels of adjacent pieces of video pixel data among the pieces of video pixel data arranged in the matrix is small.

In a specific aspect 6 of any one of aspects 1 to 5, k is 4, four pieces of video pixel data arranged in two rows and two columns among the pieces of video pixel data arranged in the matrix correspond to one panel pixel, and the display control circuit shifts four projection positions clockwise or counterclockwise with respect to the optical path shift element.

What is claimed is:

1. A projection display device comprising:
a liquid crystal panel including a plurality of panel pixels, a first panel pixel and a second panel pixel among the plurality of panel pixels being adjacent to each other,
an optical path shift element configured to shift an optical path of projection light projected from the panel pixels to shift a position of the projected pixel, and
a display control circuit configured to control the liquid crystal panel and the optical path shift element, wherein
k pieces of video pixel data among video pixel data constituting video data input to the liquid crystal panel and arranged in a matrix individually correspond to the first panel pixel in the k unit periods, k being an integer equal to or greater than 2,
the k pieces of video pixel data individually correspond to the second panel pixel in the k unit periods,
the k pieces of video pixel data corresponding to the first panel pixel and the k pieces of video pixel data corresponding to the second panel pixel are different, and
the display control circuit
controls the shift of the position of the projected pixel with respect to the optical path shift element for each of the k unit periods,
supplies a data signal based on the video pixel data corresponding to the one unit period to the first panel pixel, and the data signal based on the video pixel data corresponding to the one unit period to the second panel pixel in one unit period among the k unit periods,
corrects at least a second gradation level so that a difference between a first gradation level of first video pixel data corresponding to the one unit period among the k pieces of video pixel data corresponding to the first panel pixel and the second gradation level of second video pixel data corresponding to the one unit period is reduced, and
adjusts gradation levels of k−1 pieces of video pixel data including the second video pixel data that are consecutive with respect to the first video pixel in a direction in which the second video pixel is located to a value that is the same as the corrected second gradation level.

2. The projection display device according to claim 1, wherein the display control circuit corrects the first gradation level in addition to the second gradation level.

3. The projection display device according to claim 2, wherein the display control circuit corrects the first gradation level and the second gradation level when the first gradation level is less than a first threshold and the second gradation level is equal to or greater than a second threshold.

4. The projection display device according to claim 3, wherein the display control circuit corrects the first gradation level less than the first threshold to be equal to or greater than the first threshold, and corrects the second gradation level equal to or greater than the second threshold to be less than the second threshold.

5. The projection display device according to claim 4, wherein the display control circuit performs the correction so that a difference between gradation levels of adjacent pieces of video pixel data among the pieces of video pixel data arranged in the matrix is small.

6. The projection display device according to claim 1, wherein
k is 4,
four pieces of video pixel data arranged in two rows and two columns among the pieces of video pixel data arranged in the matrix correspond to one panel pixel, and
the display control circuit shifts four projection positions clockwise or counterclockwise with respect to the optical path shift element.
